(19) United States
(12) Patent Application Publication
(10) Pub. No.: US 2026/0336443 A1
(43) Pub. Date: Oct. 29, 2026

(54) CHARGING SYSTEM FOR AN ELECTRIC OR HYBRID VEHICLE AND ASSOCIATED VEHICLE

(71) Applicant: AMPERE S.A.S., Boulogne Billancourt (FR)

(72) Inventors: Maria AGAPIOS, Guyancourt Cedex (FR); Abdelhakim DEBIB, Guyancourt Cedex (FR); Bruno MANGIN, Guyancourt Cedex (FR); Serge RAVARY, Guyancourt Cedex (FR)

(73) Assignee: AMPERE S.A.S., Boulogne Billancourt (FR)

(21) Appl. No.: 19/139,653

(22) PCT Filed: Nov. 30, 2023
(86) PCT No.: PCT/EP2023/083833

§ 371 Date: Jun. 22, 2026

(30) Foreign Application Priority Data
Dec. 16, 2022 (FR) FR2213557

(51) Int. Cl. B60L 53/24; B60L 50/40; B60L 50/51; B60L 50/60; B60L 53/16; B60L 53/22; B60L 53/60; B60L 58/12; H02M 7/5387

(52) U.S. Cl. CPC B60L 53/24; B60L 50/40; B60L 50/51; B60L 50/60; B60L 53/16; B60L 53/22; B60L 53/60; B60L 58/12; H02M 7/53871; B60L 2210/40; B60L 2240/547

(57) ABSTRACT

A charging system for an electric or hybrid vehicle includes a traction battery, an inverter and an AC motor. The charging system includes a voltage booster assembly, first connection means configured to connect the traction battery to the input of the inverter and second connection means configured to connect a charging socket to the input of the voltage booster assembly. The charging system further includes third connection means configured to connect the traction battery directly to the charging socket.

The present invention relates to the automotive and electro-technical fields and is more specifically concerned with a charging system for an electric or hybrid vehicle and with a vehicle comprising such a charging system.

An electric or hybrid vehicle comprises a high-voltage traction battery which discharges to power an electric traction motor providing traction to the vehicle. This vehicle therefore requires a system for charging the traction battery. Such a system recharges the traction battery by recuperating energy when the vehicle is braking, or from a charging station external to the vehicle. Now, charging stations do not all provide the same type of charging. The vehicle charging system therefore needs preferably to comprise multiple types of charger dependent on the type of charging, for example a charger dedicated to AC charging and a device dedicated to DC charging by means of an external charger.

To meet all of these requirements, such a charging system may therefore prove to be extremely bulky and extremely expensive particularly if certain components of the charging system are not rendered as multipurpose as possible. It is notably known practice to use the stator field coils of an electric vehicle traction electric motor, and the associated traction inverter, to create a vehicle charger voltage booster stage, as described for example in document FR2943188.

Likewise, in order to reduce the cost and complexity of the charging system, it is preferable to use only a single charging socket for connecting to a DC charging station, whatever the level of voltage that this charging station is able to supply. However, certain vehicles now comprise traction batteries with a maximum no-load voltage much greater than the maximum available voltage level output by conventional charging stations, which means that, in such a vehicle, the charging socket used for DC charging can no longer be directly connected to the traction battery of the vehicle, but must be connected to the input of a voltage-boosting stage the output of which is connected to the traction battery.

When this voltage-boosting stage uses the stator field coils of an electric motor of the vehicle and an inverter of the vehicle, this means that this motor and this inverter need to be specified to be able to withstand the traction-battery charging current, whatever the level of voltage supplied by the charging station. In other words, even if, for example, for the normal running of the vehicle, an electric motor and an inverter able to withstand a maximum phase current of 130 A (amps) will suffice, the vehicle will need to incorporate an electric motor and an inverter able to withstand a far higher maximum phase current corresponding to a traction-battery charging current supplied by a charging station that delivers a charging voltage that is likewise very high, for example of the order of 800 V (volts).

In addition, systematically passing the traction-battery charging current through the voltage-boosting stage leads to electrical losses in the components of the voltage-boosting stage, even when its voltage-boosting function is not being used.

Finally, the design of such a charging system is guided by the desire to minimize the number of controlled switches so as to reduce the cost of the system, the bulk and the complexity thereof, and also by the desire to minimize the number of times these switches are activated, in order to avoid premature wearing thereof.

The present invention seeks to at least partially overcome the disadvantages of the prior art by providing a charging system for an electric or hybrid vehicle, and such a vehicle, enabling a traction battery of the vehicle to be charged using a DC charging station regardless as to whether the level of voltage supplied by the charging station is lower than or higher than that of the traction battery, without the need for over-specifying an electric motor and an inverter of the vehicle, and while minimizing electrical losses during this charging.

To this end, the present invention proposes a charging system for an electric or hybrid vehicle, the vehicle comprising a traction battery, an inverter able to be connected at input to the traction battery and connected at output to an AC motor, the charging system comprising a voltage booster assembly, the charging system additionally comprising first connection means for connecting the traction battery to the input of the inverter and second connection means for connecting a charging socket to an input of the voltage boost assembly,
the charging system being characterized in that it further comprises third connection means able to connect the traction battery directly to the charging socket.

What is meant by “connecting directly” is that the third connection means are able to connect the charging socket to the terminals of the traction battery without passing via the voltage booster assembly, there being only a few conductors or components of zero resistance or near-zero resistance separating the charging socket from the traction battery when the third connection means are used.

In addition, in the present patent application, unless otherwise stated, a connection to an input or output of a functional assembly such as the inverter or the voltage booster assembly is understood to be a connection to the terminals of this input or output, respectively, i.e. a parallel connection to this input or output, respectively. Here the output of the inverter (with respect to its inverter function) is in particular connected to the phase connections of the electric motor of the vehicle.

In the present patent application also, the traction battery is understood to be a battery powering the inverter and the electric motor when the vehicle is being driven, in contrast to an auxiliary battery of the vehicle powering a low-voltage electrical network of the vehicle (14 V for example) to which various consumers including a main computer of the vehicle are connected. The traction battery may therefore also be understood to be a propulsion battery depending on the electric motor used. Unless otherwise stated, the battery being referred to in the present patent application is the traction battery of the vehicle. Similarly, in the present patent application the terms “motor” and “inverter” refer to an electric traction or propulsion motor and to a traction or propulsion inverter of the vehicle, in the absence of any indication to the contrary. Lastly, the terms “charging” and “recharging” are considered equivalent in the present patent application.

By virtue of the invention, a DC current for charging the traction battery passes through the voltage booster assembly when the first and second connection means are used, or reaches the traction battery directly when the first and third connection means are used. The latter instance corresponds to charging while the vehicle is connected to a charging station supplying a charging voltage that is higher than a voltage across the terminals of the traction battery. Because it does not pass through the voltage booster assembly, the charging current delivered by such a charging station does not experience electrical losses in the voltage booster assembly. This additionally avoids the need for the electric motor and the inverter of the vehicle to be over-specified, compared with the specification they need for normal running of the vehicle, in order to allow such charging (with a charging voltage higher than the battery voltage).

As a preference, the charging system comprises the inverter, the motor and control means for controlling the inverter and the motor to form the voltage booster assembly. Thus, space in the engine compartment is saved, and the cost of using specific components to produce this voltage booster assembly is saved.

In one embodiment of the invention, in the charging system according to the invention:
the first connection means comprise at least a first switch, referred to as the battery positive switch, connected by a first of its terminals to a positive terminal of the traction battery and by a second of its terminals to a positive input terminal of the inverter, and a second switch, referred to as the battery negative switch, connected by a first of its terminals to a negative terminal of the traction battery and by a second of its terminals to a negative input terminal of the inverter,
the second connection means comprise, on the one hand, a first switch, referred to as the DC positive switch, connected by a first of its terminals to a positive terminal of the charging socket and by a second of its terminals to a positive input terminal of the voltage booster assembly, and, on the other hand, a second switch, referred to as the DC negative switch, connected by a first of its terminals to a negative terminal of the charging socket and by a second of its terminals to a negative input terminal of the voltage booster assembly, and
the third connection means comprise the DC negative switch and a switch, referred to as bypass switch, connected by a first of its terminals to the first or the second terminal of the DC positive switch and by a second of its terminals to the second terminal of the battery positive switch. As a preference, the positive input terminal of the voltage booster assembly is connected to a first terminal of a switch, referred to as booster switch, itself connected by a second of its terminals to an inductor of the voltage booster assembly. This leads to safer running, during which this booster switch is open so that no current can then pass through the voltage booster assembly. In instances in which the voltage booster assembly is formed by the inverter and the motor, the second terminal of the booster switch is connected to a neutral point of the AC motor. In addition, in that case, the negative terminal of the voltage booster assembly corresponds to the negative terminal of the inverter (in the sense that they are at the same potential).

The connections described hereinabove, in respect of the terminals of the switches are to be understood as meaning direct connections, i.e. connections made with components of zero or almost zero resistance having solely a conductive function, except potentially when they play the role of a fuse of additional switch not forming part of the subject matter of the invention.

This approach minimizes the number of switches of the charging system by using the DC negative switch both for charging the traction battery using the voltage booster assembly and for charging the battery without using that assembly. These switches are power switches, for example mechanical relays or MOSFETs (Metal Oxide Semiconductor Field Effect Transistors). The first and second terminals of each switch correspond to terminals of the switch that are distinct from each other.

In a preferred variant of this embodiment of the invention, the bypass switch is connected by its first terminal to the first terminal of the DC positive switch. This preferred variant embodiment of the invention means that the DC positive relay need not be closed when the traction battery is being charged without the use of the voltage booster assembly. In addition, when said assembly comprises an input capacitor, this variant avoids the need to couple this capacitor to a smoothing capacitor connected to the input of the traction battery, such coupling potentially adversely affecting charging or the charging system.

In another variant of this embodiment of the invention, the bypass switch is connected by its first terminal to the second terminal of the DC positive switch. In this case, the DC positive switch is closed when the traction battery is being charged without the use of the voltage booster assembly. This may be advantageous if changing directly from charging the traction battery using the voltage booster assembly to charging the traction battery not using the voltage booster assembly, as there is only one switch that needs to change state in this transition.

In this embodiment of the invention, the charging system according to the invention comprises on the one hand, communication means for communicating with a DC charging station to which the charging socket is connected, these means being able to determine a charging voltage delivered by the charging station and, on the other hand, control means controlling the first, second and third connection means, the control means being able to close the battery positive switch and negative switch and the DC positive switch and negative switch when the charging voltage determined by the communication means is lower than a voltage of the traction battery, and being able to close the DC negative switch and the bypass switch when the charging voltage determined by the communication means is higher than the maximum no-load voltage of the traction battery. Naturally, in the event that the charging voltage determined by the communication means is lower than the traction-battery voltage, the bypass which is opened or kept open. Likewise, in the event that the charging voltage determined by the communication means is higher than the traction-battery voltage, the DC positive switch is opened or kept open in the preferred variant of this embodiment of the invention. In the other variant on the other hand, the DC positive switch is kept closed or is closed when the charging voltage determined by the communication means is higher than the traction-battery voltage. Finally, the control means are able to close the battery positive and negative switches and the DC positive and negative switches if the charging voltage determined by the communication means is higher than the traction-battery voltage but lower than the maximum no-load voltage of the traction battery.

As a preference, the voltage booster assembly further comprises a capacitor, referred to as the booster capacitor, connected by a first of its terminals to the negative input terminal of the voltage booster assembly and by a second of its terminals to the first terminal of the booster switch. This capacitor notably makes the start of charging using the voltage booster assembly safer.

The invention also relates to an electric or hybrid vehicle comprising the charging system according to the invention and the traction battery, characterized in that it further comprises a connection unit, the connection unit comprising a connector electrically connected to the input of the inverter, a connector electrically connected to the charging socket, a connector electrically connected to the traction battery, and a connector electrically connected to the positive input terminal of the voltage booster assembly, and the connection unit comprising the battery positive switch and negative switch, the DC positive switch and negative switch and the bypass switch. This unit makes for easier wiring and assembly.

The connection unit also comprises a pre-charging device of which a first terminal is connected to the positive terminal of the battery and a second terminal is connected to the positive input terminal of the inverter.

The term “electrically connected” means a direct connection without an intermediate switch. The connection unit therefore enables the main switches of the charging system (with the exception of the voltage booster switch) to be grouped together and electrical safety established around these main switches, particularly when these are mechanical relays. The connection unit also makes maintenance on these main switches easier.

In one embodiment of the invention, the electric or hybrid vehicle according to the invention further comprises a smoothing capacitor connected to the output of the voltage booster assembly. This smoothing capacitor is therefore connected to the input of the inverter and serves to smooth the current delivered to the traction battery when the inverter is operating as a rectifier when recuperating braking energy, or when the voltage booster assembly is operating as a voltage booster.

According to advantageous feature of the electric or hybrid vehicle according to the invention, said vehicle comprises detection means detecting sticking of the bypass switch following a charging of the traction battery using the bypass switch. This detection makes it possible to prevent the traction battery from being charged using a charging station with an available voltage level lower than that of the traction battery, until such time as this switch has been changed. What is meant here by “sticking” is that, in the case of a mechanical relay, the switch has become welded to its terminals or, in the case of a MOSFET, that the switch has become damaged to the point of being impossible to turn off.

Advantageously, the electric or hybrid vehicle according to the invention comprises control means controlling a voltage of the traction battery and a current of the traction battery, the control means being able to open the battery positive switch and negative switch and/or the DC positive switch and negative switch and/or the bypass switch when the control means detect an anomaly. This anomaly is, for example, an excessively rapid increase in the voltage of the battery or of some of the battery cells.

Other features and advantages of the invention will become more apparent from the following description, on the one hand, and from a plurality of non-limiting exemplary embodiments that are given by way of indication with reference to the appended schematic drawings, on the other hand, in which drawings:

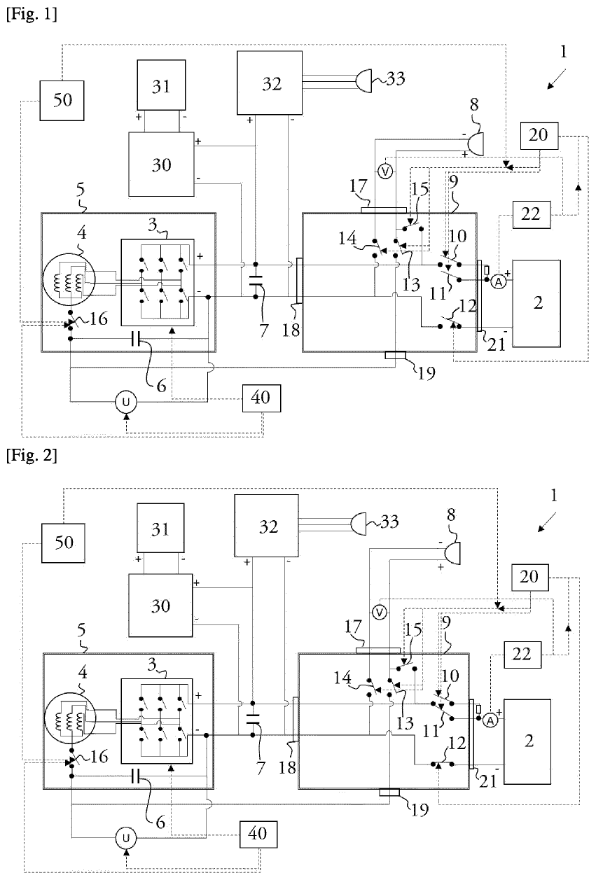

FIG. 1 illustrates a charging system for charging a traction battery of an electric or hybrid vehicle according to the invention, in one embodiment of the invention,

FIG. 2 illustrates the position of switches of the charging system of FIG. 1 in a situation of normal running of the vehicle,

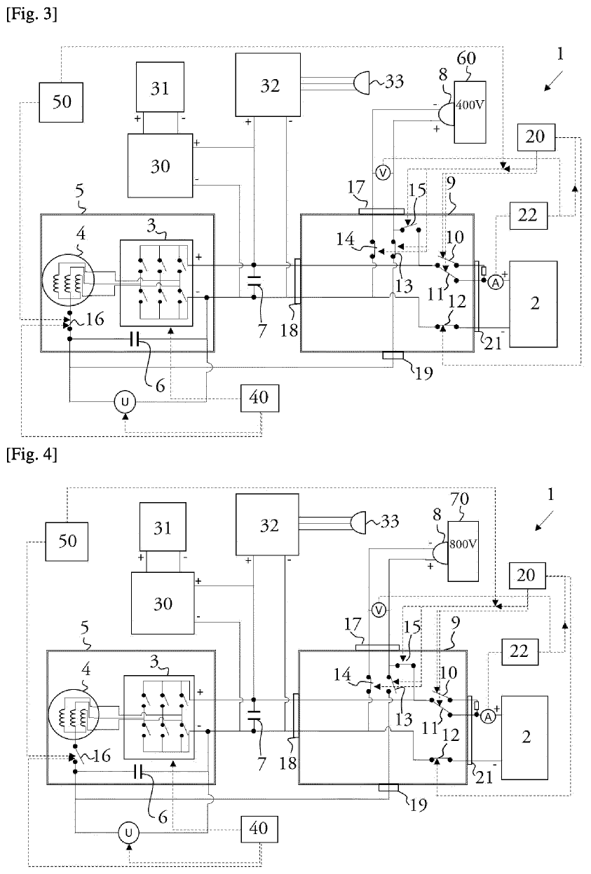

FIG. 3 illustrates the position of these switches during charging of the traction battery using a charging station capable of supplying, at most, a voltage that is lower than the maximum no-load voltage of the traction battery, and

FIG. 4 illustrates the position of these switches during charging of the traction battery using a charging station capable of supplying, at most, a charging voltage that is higher than the maximum no-load voltage of the traction battery.

According to one embodiment of the invention illustrated in FIG. 1, an electric or hybrid vehicle according to the invention comprises a charging system 1 according to the invention, for recharging a traction battery 2 of the vehicle. The vehicle comprises a traction inverter 3 and a three-phase electric motor 4 connected to the wheels of the vehicle by a drivetrain, the inverter 3 and the motor 4 being powered by the traction battery 2 with a view to setting the vehicle in motion.

To this end, the vehicle comprises, to connect the traction battery 2 to the inverter 3, a first switch 11, referred to as the battery positive switch, connected by a first of its terminals to a positive terminal of the traction battery 2 and by a second of its terminals to a positive input terminal of the inverter 3, and a second switch 12, referred to as the battery negative switch 12, connected by a first of its terminals to a negative terminal of the traction battery 2 and by a second of its terminals to a negative input terminal of the inverter 3. By input of the inverter what is meant here is the part of the inverter that receives a DC current and transmits a rectified current, i.e. the term “input” is to be understood with respect to the inverter function. Likewise, in the present patent application, the terms “input” and “output” are to be understood with respect to the function of the electrical assembly or component to which reference is being made. A smoothing capacitor 7 is connected to the input of the inverter. This capacitor makes it possible to smooth the current entering the battery 2 when the inverter 3 is used as a rectifier of the current output by the electric motor 4 operating in generator mode.

The battery positive switch 11 and negative switch 12 therefore form first means of connection of the traction battery 2 to the input of the inverter 3.

Moreover, the output of the inverter 3 is directly connected to the electric motor 4, i.e. without intermediate switch.

The vehicle also comprises a DC-DC converter 30 connected to the terminals of the smoothing capacitor 7 and allowing the recharging of an auxiliary battery 31 intended to power consumers (lighting system, etc.) of the vehicle. The vehicle also comprises a charger 32 able to recharge the traction battery 2 using an AC charging station. The charger 32 is connected at output to the terminals of the smoothing capacitor 7 and at input to a charging socket 33 specific to AC recharging. This charging socket 33 is, for example a type-2 connector conforming to the standard IEC 62196 (set of standards of the International Electrotechnical Commission).

The vehicle further comprises a charging socket 8 intended to be connected to a DC charging station. This charging socket 8 is, for example, a CHAdeMO connector conforming to the standard IEC 61851-23, -24. As a variant, the vehicle comprises only one charging socket allowing connection both to a DC charging station and an AC charging station, for example a Combo DC charging socket complying with the standard IEC 62196-3. In yet another variant, the vehicle has only one charging socket intended exclusively to be connected to a DC charging station.

The charging system 1 comprises control means 40 for commanding the inverter 3 and the motor 4 to use the assembly 5 of the inverter 3 and of the motor 4 as a voltage booster stage when the traction battery 2 is being charged using a charging voltage delivered by a charging station that is lower than the maximum no-load voltage of the traction battery 2. In this case, the stator field coils of the electric motor 4 are then used as current-storage inductors in the voltage boost assembly 5, these stator field coils discharging into the traction battery 2 through the inverter 3 during a duty cycle of switching of the switches of the inverter 3, which is set by the control means 40, which comprise a voltmeter U measuring voltage across the terminals of the booster capacitor 6.

A negative terminal of the booster capacitor 6 is connected to the negative input terminal of the inverter, and a positive terminal of the booster capacitor 6 is connected to the neutral point of the electric motor 4 via a switch 16. The switch 16 referred to as the booster switch is connected by a first of its terminals to the positive terminal of the booster capacitor 6 and by a second of its terminals to the neutral point of the electric motor 4. This booster switch 16 makes it possible to disconnect the booster capacitor 6 at the input of the voltage booster assembly 5 outside of phases of charging of the traction battery 2 by an external charging station, this booster switch 16 in particular being kept open when the vehicle is being driven. Thus, when the vehicle is being driven, capacitive coupling of the booster capacitor 6 with the electric motor 4 is avoided.

The means 40 of control of the inverter 3 are, for example, a microcontroller controlling the switches of the inverter 3, both in the traction mode and in the mode of charging of the vehicle, when this charging mode uses the booster function of the assembly 5.

Second connection means of the vehicle enable the DC charging socket 8 to be connected to the input of the voltage booster assembly 5. To do that, these second means comprise:
a switch 13, referred to as the DC positive switch, connected by a first of its terminals to a positive terminal of the charging socket 8 and by a second of its terminals to the booster switch 16, and
a switch 14, referred to as the DC negative switch, connected by a first of its terminals to a negative terminal of the charging socket 8 and by a second of its terminals to the negative input terminal of the inverter 3.

These second connection means are used for recharging the traction battery 2 via the voltage booster assembly 5 when a charging voltage of a charging station to which the charging socket 8 is connected is lower than the maximum no-load voltage of the battery 2.

Finally, third connection means of the vehicle enable the DC charging socket 8 to be connected directly to the traction battery 2, and are used for recharging this battery when a charging voltage of a charging station to which the charging socket 8 is connected is higher than the voltage across the terminals of the battery 2. The third connection means comprise the DC negative switch 14 and a switch 15, referred to as the bypass switch, connected by a first of its terminals to the first to the first terminal of the DC positive switch 13, and by a second of its terminals to the second terminal of the battery positive switch 11. As a variant, the bypass switch 15 is connected by the first of its terminals to the second terminal of the DC positive switch 13, and by the second of its terminals to the second terminal of the battery positive switch 11.

The switches 11, 12, 13, 14 and 15 are, in this instance, mechanical relays grouped together in a connection unit 9 of the charging system 1. The connection unit also comprises a pre-charging relay 10 connected by one of its terminals to the positive terminal of the traction battery 2 and by the other of its terminals to the positive terminal of the inverter 3. A pre-charging resistor is connected between the pre-charging relay 10 and the positive terminal of the battery 2. Before any charging of the battery 2, the pre-charging relay 10 is first closed to charge the smoothing capacitor 7, then the pre-charging relay 10 is opened and the battery positive relay 11 is closed. The pre-charging relay 10 and the pre-charging resistor form a pre-charging device. It will be noted that other types of pre-charging devices may be used instead of such a relay-and-resistor system.

The electrical outputs from the connection unit 9 are made via electrical connectors 17, 18, 19 and 21. The connector 18 is electrically connected to the input of the inverter 3, the connector 17 is electrically connected to the charging socket 8, the connector 21 is electrically connected to the traction battery 2, and the connector 19 is electrically connected to the positive terminal of the booster capacitor 6.

The charging system 1 in this embodiment of the invention comprises the voltage booster assembly 5, the charger 32, the charging sockets 8 and 33, and the connection unit 9. It also comprises one or more software and/or hardware modules of a main computer 50 of the vehicle. In particular, the main computer 50 comprises means of communication with a charging station 60 or 70 (referenced in FIGS. 3 and 4), which form part of the charging system 1.

The charging system 1 also comprises control means controlling, on the one hand, the second and third connection means and, on the other hand, the booster switch 16, these control means being present in the main computer 50 of the vehicle.

The charging system 1 also comprises control means for controlling the pre-charging relay 10 and the battery positive switch 11 and negative switch 12, these control means also being present in a management system 20 managing the traction battery 2 and possibly forming an integral part of the charging system 1. The management system 20 for managing the battery 2 is coupled to a sensor 22 sensing a current entering the battery 2 (this sensor 22 being connected to the ammeter A in FIG. 1) and sensing a charging voltage supplied by the charging station 60, 70 (this sensor 22 being connected to the voltmeter V in FIG. 1), enabling it to supervise the charging of the battery 2. The management system 20 for managing the battery 2 also comprises control means for controlling the bypass switch 15 and the DC positive switch 13 and negative switch 14. Thus, when the system 20 for managing the battery 2 detects a fault during charging, it may interrupt it for safety's sake without intervention by the main computer 50 of the vehicle. The switches 10, 11, 12, 13, 14, 15 are therefore each controllable by the managing system 20 and by the main computer 50 of the vehicle, thus achieving a safety-related redundancy. Likewise, the booster switch 16 is controllable by the main computer 50 and by the control means 40.

To further reinforce the safety of the charging system 1, the main computer 50 detects potential sticking of one of the switches 10, 11, 12, 13, 14, 15 or 16 used during charging of the traction battery, at the end of this charging, and imposes a downgraded mode of operation on the vehicle if such sticking is detected. This detection uses, for example, voltage measurements taken at various points in the charging system 1.

The operation of the charging system 1 is now explained in relation to the various scenarios of use of the vehicle, in which the maximum no-load voltage of the traction battery is 800 V. Of course, the invention can be used with batteries having a maximum no-load voltages of different values.

When the vehicle is being driven, as depicted in FIG. 2, the DC positive switch 13 and negative switch 14, the bypass switch 15, the pre-charging relay 10 and the booster switch 16 are kept open by the charging system 1, while the battery positive switch 11 and negative switch 12 are kept closed. Thus, the traction battery 2 supplies power to the inverter 3 and the electric motor 4 which provides the propulsion or traction of the vehicle. It should be noted that, in this situation, the bypass switch 15 could be kept closed, for example in order to limit the number of times that it is actuated or as a result of this switch being faulty, without this impairing the operation of the vehicle in normal running. By contrast, in the embodiment variant in which the bypass switch 15 is connected by one of its terminals directly to the positive terminal of the booster capacitor 6 (i.e. without the DC positive switch being situated between these two components), closure of this switch would cause the booster capacitor 6 to be coupled with the electric motor 4, and this would be detrimental.

FIG. 3 illustrates a situation whereby the traction battery 2 is being charged using the charging station 60 which does not deliver a voltage level higher than the maximum no-load voltage of the battery. For example, this charging station is able at most to deliver a charging voltage of 400 V or of 500 V. It is assumed, in this example of use of the invention, that the voltage across the terminals of the battery 2 is higher than a maximum charging voltage delivered by the charging station 60. The computer 50 has been able to determine this maximum charging voltage and the fact that it is lower than the maximum no-load voltage of the battery 2, prior to the charging of the battery 2, by communicating with the charging station 60. During this charging, the charging system 1 keeps the booster switch 16, the DC positive switch 13 and negative switch 14, and the battery positive switch 11 and negative switch 12 closed. By contrast, the charging system 1 keeps the bypass switch 15 open. It should be noted that, during this charging, the pre-charging relay 10, managed by the management system 20, is also left open (except during the pre-charging period that precedes this charging of the traction battery 2, in which the pre-charging relay 10 is closed and the battery positive relay 11 open).

In this situation, the charging voltage applied by the charging station 60 is applied to the booster capacitor 6, and the control means 40 that control the inverter command the voltage booster assembly 5 so that a voltage supplied at output of this voltage booster assembly 5 (and therefore to the input of the inverter) is higher than the voltage of the battery 2.

FIG. 4 illustrates a situation whereby the traction battery 2 is being charged using the charging station 70 which delivers a voltage level that may be as high as 820 V. The main computer 50, having communicated with the charging station 70, has demanded a charging voltage higher than the battery voltage 2, which is itself lower than 800 V (given that it needs to be recharged). During the charging of the traction battery 2 with this charging station 70, the charging system 1 keeps the booster switch 16 and the DC positive switch 13 open. During this charging, the pre-charging relay 10 is kept open (except during the pre-charging period that precedes this charging of the traction battery 2, in which the pre-charging relay 10 is closed and the battery positive relay 11 open). By contrast, it keeps the DC negative switch 14, the bypass relay 15 and the battery positive switch 11 and negative switch 12 closed.

In this situation, the charging voltage delivered by the charging station 70 is applied directly to the terminals of the traction battery 2, without any electrical losses generated by the inverter 3 or by the electric motor 4, and also without any undesirable capacitive effect. It should be noted that, by contrast, in the embodiment variant in which the bypass switch 15 is connected by one of its terminals directly to the positive terminal of the booster capacitor 6, there is coupling between the booster capacitor 6 and the smoothing capacitor 7, and this is detrimental to the recharging of the battery 2. In addition, in this variant, the DC positive switch 13 is kept closed during this charging.

Of course, the invention is not limited to the examples that have just been described and many modifications may be made to these examples without departing from the scope of the invention.

1. A charging system (1) for an electric or hybrid vehicle, the vehicle comprising a traction battery (2), an inverter (3) able to be connected at input to the traction battery (2) and connected at output to an AC motor (4), the charging system (1) comprising a voltage booster assembly (5), the charging system (1) additionally comprising first connection means (11, 12) for connecting the traction battery (2) to the input of the inverter (3) and second connection means (13, 14) for connecting a charging socket (8) to an input of the voltage booster assembly (5),
the charging system (1) being characterized in that it further comprises third connection means (14, 15) able to connect the traction battery (2) directly to the charging socket (8).

2. The charging system (1) as claimed in claim 1, comprising the inverter (3), the motor (4) and control means (40) for controlling the inverter (3) and the motor (4) to form the voltage booster assembly (5).

3. The charging system (1) as claimed in claim 1 or 2, wherein:
the first connection means (11, 12) comprise at least a first switch (11), referred to as the battery positive switch, connected by a first of its terminals to a positive terminal of the traction battery (2) and by a second of its terminals to a positive input terminal of the inverter (3), and a second switch (12), referred to as the battery negative switch, connected by a first of its terminals to a negative terminal of the traction battery (2) and by a second of its terminals to a negative input terminal of the inverter (3),
the second connection means (13, 14) comprise, on the one hand, a first switch (13), referred to as the DC positive switch, connected by a first of its terminals to a positive terminal of the charging socket (8) and by a second of its terminals to a positive input terminal of the voltage booster assembly (5), and, on the other hand, a second switch (14), referred to as the DC negative switch, connected by a first of its terminals to a negative terminal of the charging socket (8) and by a second of its terminals to a negative input terminal of the voltage booster assembly (5), and
the third connection means (14, 15) comprise the DC negative switch (14) and a switch (15), referred to as bypass switch, connected by a first of its terminals to the first or the second terminal of the DC positive switch (13) and by a second of its terminals to the second terminal of the battery positive switch (11).

4. The charging system (1) as claimed in claim 3, wherein the positive input terminal of the voltage booster assembly (5) is connected to a first terminal of a switch (16), referred to as booster switch, itself connected by a second of its terminals to an inductor of the voltage booster assembly (5).

5. The charging system (1) as claimed in claim 3 or 4, wherein the bypass switch (15) is connected by its first terminal to the first terminal of the DC positive switch (13).

6. The charging system (1) as claimed in any one of claims 3 to 5 comprising, on the one hand, communication means (50) for communicating with a DC charging station (60, 70) to which the charging socket (8) is connected, these means being able to determine a charging voltage delivered by the charging station (60, 70) and, on the other hand, control means controlling the first, second and third connection means, the control means being able to close the battery positive switch (11) and negative switch (12) and the DC positive switch (13) and negative switch (14) when the charging voltage determined by the communication means (50) is lower than a voltage of the traction battery (2), and being able to close the DC negative switch (14) and the bypass switch (15) when the charging voltage determined by the communication means (50) is higher than the maximum no-load voltage of the traction battery (2).

7. The charging system (1) as claimed in any one of claims 4 to 6, characterized in that the voltage booster assembly (5) further comprises a capacitor (6), referred to as the booster capacitor, connected by a first of its terminals to the negative input terminal of the voltage booster assembly (5) and by a second of its terminals to the first terminal of the booster switch (16).

8. An electric or hybrid vehicle comprising a charging system (1) as claimed in any one of claims 3 to 7 and the traction battery (2), characterized in that it further comprises a connection unit (9), the connection unit (9) comprising a connector (18) electrically connected to the input of the inverter (3), a connector (17) electrically connected to the charging socket (8), a connector (21) electrically connected to the traction battery (2), and a connector (19) electrically connected to the positive input terminal of the voltage booster assembly (5), and wherein the connection unit (9) comprises the battery positive switch (11) and negative switch (12), the DC positive switch (13) and negative switch (14) and the bypass switch (15).

9. The electric or hybrid vehicle as claimed in claim 8, comprising detection means (50) detecting sticking of the bypass switch (15) following a charging of the traction battery (2) using the bypass switch (15).

10. The electric or hybrid vehicle as claimed in claim 8 or 9, comprising control means (20, 50) controlling a voltage of the traction battery (2) and a current of the traction battery (2), the control means (20, 50) being able to open the battery positive switch (11) and negative switch (12) and/or the DC positive switch (13) and negative switch (14) and/or the bypass switch (15) when the control means (20, 50, 40) detect an anomaly.
